(19) United States
(12) Patent Application Publication
(10) Pub. No.: US 2026/0342632 A1
(43) Pub. Date: Oct. 29, 2026

(54) DEVICES AND METHODS FOR EFFICIENT AND ROBUST OFDM WI-FI COMMUNICATION

(71) Applicant: HUAWEI TECHNOLOGIES CO., LTD., Shenzhen (CN)

(72) Inventors: Genadiy Tsodik, Hod Hasharon (IL); Shimon Shilo, Hod Hasharon (IL); Doron Ezri, Hod Hasharon (IL); Ezer Melzer, Hod Hasharon (IL); Oded Redlich, Hod Hasharon (IL)

(73) Assignee: HUAWEI TECHNOLOGIES CO., LTD., Shenzhen (CN)

(21) Appl. No.: 19/701,418

(22) Filed: Jun. 8, 2026

Related U.S. Application Data
(63) Continuation of application No. PCT/EP2023/084912, filed on Dec. 8, 2023.

(51) Int. Cl. H04L 27/26

(52) U.S. Cl. CPC H04L 27/26132

(57) ABSTRACT

A Wi-Fi transmitter station for orthogonal frequency division multiplexing (OFDM) based communication with a Wi-Fi receiver station via a wireless channel, where the Wi-Fi transmitter station generates a signal carrying a physical-layer protocol data unit (PPDU). The PPDU includes a preamble part and a data part, where the signal carrying the PPDU is modulated over a plurality of subcarriers spanning a plurality of OFDM symbols. The Wi-Fi transmitter station transmits the signal to the Wi-Fi receiver station, where the preamble part of the PPDU further includes a dedicated field including one or more OFDM symbols with a guard interval (GI) duration larger than a GI duration of the plurality of OFDM symbols of the data part.

### CROSS-REFERENCE TO RELATED APPLICATIONS

This application is a continuation of International Application No. PCT/EP2023/084912, filed on Dec. 8, 2023, the disclosure of which is hereby incorporated by reference in its entirety.

### FIELD

The present disclosure relates to wireless communications, Wi-Fi transmitter and receiver stations, such as access points (APs) and non-AP stations, and methods for efficient and robust communication in a wireless communication network, in particular a Wi-Fi network, i.e. a wireless communication network according to the IEEE 802.11 framework of standards.

### BACKGROUND

IEEE 802.11-based WLANs (also referred to as Wi-Fi networks) have become popular at an unprecedented rate. There are some proposals for extending Wi-Fi technology to operation in the 42.5 to 71 GHz frequency range (also referred to as Integrated mmWave (IMMW) operation). It has been proposed, for instance, to reuse sub-7 GHz Wi-Fi technology at these higher frequencies by simply upclocking the physical (layer) (PHY) signal for generating a larger subcarrier spacing. This solution is relatively simple (from both standardization & implementation viewpoints), while allowing to overcome the phase noise (PN) impairments which are substantially higher in mmWave with low-cost Radio Frequency (RF) technology. However, a simple upclocking of the PHY signal implies also a shorter Orthogonal Frequency Division Multiplexing (OFDM) symbol duration, which may be reduced to even 400 nanoseconds. A shorter OFDM symbol also implies a shorter guard interval (GI) often implemented as a cyclic prefix (CP) extension of the OFDM symbol; however, in some deployment scenarios a short GI might impair the communication performance in practice.

### SUMMARY

Embodiments of the present disclosure provide improved devices, in particular Wi-Fi transmitter and receiver stations, such as APs and non-AP stations, and methods for efficient and robust communication in a wireless communication network addressing the trade-off between a larger subcarrier spacing and the guard interval duration, in particular for the 42.5 to 71 GHz frequency range.

According to a first aspect a Wi-Fi transmitter station for orthogonal frequency division multiplexing (OFDM) based communication with a Wi-Fi receiver station via a wireless channel is provided. As used herein, OFDM based communication may be Orthogonal Frequency Division Multiplexing/Multiple-Access (OFDMA) based communication. In an embodiment, the Wi-Fi transmitter station is a Wi-Fi transmitter station in accordance with the IEEE 802.11 framework of standards.

The Wi-Fi transmitter station according to the first aspect is configured to generate a signal carrying a physical-layer protocol data unit (PPDU), wherein the PPDU comprises a preamble part and a data part and wherein the signal carrying the PPDU is modulated over a plurality of frequency subcarriers spanning a plurality of OFDM symbols. Moreover, the Wi-Fi transmitter station is configured to transmit the signal to the Wi-Fi receiver station, wherein the preamble part of the PPDU further comprises a dedicated field comprising one or more OFDM symbols with a GI duration substantially larger than a GI duration of the plurality of OFDM symbols of the data part, i.e. inserted between the plurality of OFDM symbols of the data part. By including the dedicated field with the one or more OFDM symbols the Wi-Fi transmitter station increases the robustness of the communication link between the Wi-Fi transmitter station and a Wi-Fi station receiving the transmitted signal, while preserving efficiency. The increased robustness is reflected in maintaining efficient transfer of data between the transmitting and receiving stations even when the wireless channel between them is characterized by a large delay spread, in particular larger than the duration of the GIs inserted between the OFDM symbols in the data part of the PPDU.

In an embodiment, the Wi-Fi transmitter station is configured to transmit the signal with a carrier frequency above 40 GHz.

In an embodiment of the present disclosure, the preamble part of the PPDU includes one or more bits indicative of the GI duration of each OFDM symbol of the data part being larger than 100 nanoseconds.

In embodiments, the preamble part of the PPDU includes one or more bits indicative of the GI duration of each OFDM symbol of the data part being about 200, 400 or 500 nanoseconds.

In an embodiment, the duration of the GI inserted between each consecutive pair of OFDM symbols of the data part of the PPDU is not larger than a quarter of the duration of each one of the OFDM symbols. This implies, equivalently, that the time overhead spent by the insertion into the transmitted signal of GIs, in between the OFDM symbols carrying the data included in the PPDU, is not larger than 25%.

In an embodiment of the present disclosure, the dedicated field is a channel shortening training field and the one or more OFDM symbols of the dedicated field comprise a channel shortening training sequence, wherein based on the received channel shortening training sequence the Wi-Fi receiver station is configured to apply a channel shortening filter for suppressing components of the wireless channel having delays larger than the GI duration of the OFDM symbols in the data part of the PPDU.

In embodiments, the channel shortening training sequence comprises a training OFDM symbol and at least one complete or partial time-domain copy of the training OFDM symbol.

In an embodiment, in the preamble part of the PPDU the channel shortening training field is arranged between a very high throughput (VHT) short training field (STF), and a VHT long training field (LTF), or between fields corresponding to the VHT-STF and/or the VHT-LTF in other Wi-Fi standards, such as further evolutions of the IEEE 802.11 Wi-Fi framework of standards, in particular HT/EHT-STF and/or HT/EHT-LTF.

In an embodiment of the present disclosure, the channel shortening training field replaces the VHT-LTF or a field corresponding to the VHT-LTF in other Wi-Fi standards, such as further evolutions of the IEEE 802.11 Wi-Fi framework of standards.

In embodiments, in the preamble part of the PPDU the channel shortening training field is arranged after a legacy signal field (L-SIG), and the format of the preamble part preserves the legacy part.

In an embodiment, in the preamble part of the PPDU the channel shortening training field is arranged between a legacy long training field (L-LTF) and a legacy signal field (L-SIG).

In an embodiment of the present disclosure, in the preamble part of the PPDU the channel shortening training field is arranged between a legacy short training field (L-STF) and a legacy long training field (L-LTF).

In embodiments, in the preamble part of the PPDU the channel shortening training field replaces the legacy long training field (L-LTF).

In an embodiment, the PPDU further comprises an indication indicative of the channel shortening training field.

In an embodiment of the present disclosure, the preamble part of the PPDU comprises the indication.

In embodiments, the Wi-Fi transmitter station is configured to send a frame to the Wi-Fi receiver station, and wherein the frame comprises the indication.

In an embodiment, the frame is a beacon frame.

In an embodiment of the present disclosure, the indication comprises a bit or a bit sequence.

In embodiments, the indication is further indicative of the number of copies and/or the duration of the training OFDM symbol of the channel shortening training sequence.

In an embodiment, the Wi-Fi transmitter station is configured to transmit a plurality of signals to the Wi-Fi receiver station, and wherein the Wi-Fi transmitter station is configured to include the channel shortening training sequence in all of the plurality of signals.

In an embodiment of the present disclosure, the Wi-Fi transmitter station is configured to transmit a plurality of signals to the Wi-Fi receiver station, and wherein the Wi-Fi transmitter station is configured to include the channel shortening training sequence periodically in at least two of the plurality of signals.

According to a second aspect a Wi-Fi transmission method for orthogonal frequency division multiplexing (OFDM) based communication to a Wi-Fi receiver station via a wireless channel is provided. The method comprises the steps of:
generating a signal carrying a physical-layer protocol data unit (PPDU), wherein the PPDU comprises a preamble part and a data part, and wherein the signal carrying the PPDU is modulated over a plurality of frequency subcarriers spanning a plurality of OFDM symbols; and
transmitting the signal to the Wi-Fi receiver station, wherein the preamble part of the PPDU further comprises a dedicated field comprising one or more OFDM symbols with a guard interval (GI) duration substantially larger than a GI duration of the plurality of OFDM symbols of the data part.

The method according to the second aspect can be performed by the wireless transmitter station according to the first aspect. Thus, further features of the method according to the second aspect result directly from the functionality of the wireless transmitter station according to the first aspect as well as its different implementation forms described above and below.

According to a third aspect a Wi-Fi receiver station for orthogonal frequency division multiplexing (OFDM) based communication with a Wi-Fi transmitter station via a wireless channel is provided. In an implementation form, the Wi-Fi transmitter station is a Wi-Fi transmitter station in accordance with the IEEE 802.11 framework of standards.

The Wi-Fi receiver station according to the third aspect is configured to receive a signal carrying a physical-layer protocol data unit (PPDU) from the Wi-Fi transmitter station, wherein the PPDU comprises a preamble part and a data part, and wherein the signal carrying the PPDU is modulated over a plurality of frequency subcarriers spanning a plurality of OFDM symbols, wherein the preamble part of the PPDU further comprises a dedicated field comprising one or more OFDM symbols with a guard interval (GI) duration substantially larger than a GI duration of the plurality of OFDM symbols of the data part of the PPDU.

In an embodiment, the Wi-Fi receiver station is configured to receive the signal with a carrier frequency above 40 GHz.

In embodiments, the preamble part of the PPDU includes one or more bits indicative of the GI duration of each OFDM symbol of the data part of the PPDU being larger than 100 nanoseconds.

In an embodiment of the present disclosure, the preamble part of the PPDU includes one or more bits indicative of the GI duration of each OFDM symbol of the data part of the PPDU being about 200, 400 or 500 nanoseconds.

In an embodiment, the duration of the GI inserted between each consecutive pair of OFDM symbols of the data part of the PPDU is not larger than a quarter of the duration of each one of the OFDM symbols.

In embodiments, the dedicated field of the preamble part of the PPDU is a channel shortening training field and the one or more OFDM symbols of the dedicated field comprises a channel shortening training sequence, wherein based on the received channel shortening training sequence the Wi-Fi receiver station is configured to apply a channel shortening filter for suppressing components of the wireless channel having delays larger than the GI duration of the OFDM symbols of the data part of the PPDU.

In an embodiment of the present disclosure, the channel shortening training sequence comprises a training OFDM symbol and at least one complete or partial [time-domain] copy of the training OFDM symbol.

In an embodiment, in the preamble part of the PPDU the channel shortening training field is arranged between a very high throughput (VHT) short training field (STF), and a VHT long training field (LTF), or between fields corresponding to the VHT-STF and/or the VHT-LTF in further evolutions of the IEEE 802.11 Wi-Fi standard.

In embodiments, the channel shortening training sequence comprise one or more complete copies and/or a fractional copy of the VHT-STF and/or the VHT-LTF.

In an embodiment of the present disclosure, in the preamble part of the PPDU the channel shortening training field is arranged after a legacy signal field (L-SIG), and the format of the preamble part preserves the legacy part.

In an embodiment, in the preamble part of the PPDU the channel shortening training field is arranged between a legacy long training field, L-LTF, and a legacy signal field, L-SIG.

In embodiments, in the preamble part of the PPDU the channel shortening training field is arranged between a legacy short training field (L-STF) and a legacy long training field (L-LTF).

In an embodiment of the present disclosure, in the preamble part of the PPDU the channel shortening training field replaces the legacy long training field (L-LTF).

In an embodiment, the PPDU further comprises an indication indicative of the channel shortening training field.

In embodiments, the preamble part of the PPDU comprises the indication.

In an embodiment of the present disclosure, the Wi-Fi receiver station is configured to receive a frame from the Wi-Fi transmitter station and the frame comprises the indication.

In an embodiment, the frame is a beacon frame.

In embodiments, the indication comprises a bit or a bit sequence.

In an embodiment of the present disclosure, the indication is further indicative of the number of copies and/or the duration of the training OFDM symbol of the channel shortening training sequence.

In an embodiment, the Wi-Fi receiver station is configured to receive a plurality of signals from the Wi-Fi transmitter station, wherein the channel shortening training sequence is included in all of the plurality of signals.

In embodiments, the Wi-Fi receiver station is configured to receive a plurality of signals from the Wi-Fi transmitter station, wherein the channel shortening training sequence is included periodically in at least two of the plurality of signals.

According to a fourth aspect a Wi-Fi reception method for orthogonal frequency division multiplexing (OFDM) based communication between a Wi-Fi transmitter station and a Wi-Fi receiver station via a wireless channel is provided. The method according to the fourth aspect comprises the following steps:
receiving a signal carrying a physical-layer protocol data unit (PPDU) from the Wi-Fi transmitter station, wherein the PPDU comprises a preamble part and a data part, and wherein the signal carrying the PPDU is modulated over a plurality of frequency subcarriers spanning a plurality of OFDM symbols, wherein the preamble part of the PPDU further comprises a dedicated field comprising one or more OFDM symbols with a guard interval (GI) duration substantially larger than a GI duration of the plurality of OFDM symbols of the data part.

The method according to the fourth aspect can be performed by the wireless receiver station according to the third aspect. Thus, further features of the method according to the fourth aspect result directly from the functionality of the wireless receiver station according to the third aspect as well as its different implementation forms described above and below.

According to a fifth aspect a computer program product is provided, comprising program code which causes a computer or a processor to perform the method according to the second aspect or the method according to the fourth aspect, when the program code is executed by the computer or the processor.

Details of one or more embodiments are set forth in the accompanying drawings and the description below. Other features, objects, and advantages will be apparent from the description and drawings.

### BRIEF DESCRIPTION OF THE DRAWINGS

In the following, embodiments of the present disclosure are described in more detail with reference to the attached figures and drawings, in which:

FIG. 1 shows a schematic diagram illustrating a Wi-Fi network including a Wi-Fi transmitter station according to an embodiment for OFDM communication with one or more Wi-Fi receiver stations according to an embodiment of the present disclosure;

FIG. 2a shows a diagram illustrating the multipath characteristics of a wireless channel;

FIG. 2b shows a diagram illustrating an OFDM symbol with a conventional guard interval (namely, a cyclic prefix);

FIG. 2c shows a diagram illustrating a very long delay spread;

FIG. 3 shows a diagram illustrating an OFDM symbol with an extended guard interval generated by a Wi-Fi transmitter station according to an embodiment of the present disclosure;

FIG. 4 shows a schematic diagram illustrating a Wi-Fi network including a Wi-Fi transmitter station according to an embodiment for OFDM communication with a Wi-Fi receiver station according to an embodiment implementing a channel shortening filter;

FIGS. 5a and 5b show diagrams illustrating the effect of channel shortening implemented by a Wi-Fi receiver station according to an embodiment of the present disclosure;

FIG. 6 is a diagram illustrating a channel shortening training sequence transmitted as part of a PPDU by a Wi-Fi transmitter station according to an embodiment of the present disclosure;

FIGS. 7a-7d are diagrams illustrating PPDUs including a dedicated field for a channel shortening training sequence transmitted by a Wi-Fi transmitter station according to different embodiments of the present disclosure;

FIG. 8 is a table listing a plurality of bit sequences used by a Wi-Fi transmitter station according to different embodiments of the present disclosure for indicating different channel shortening training sequences;

FIG. 9 shows a flow diagram illustrating steps of a method according to an embodiment for operating a wireless transmitter station according to an embodiment of the present disclosure; and

FIG. 10 shows a flow diagram illustrating steps of a method according to an embodiment for operating a wireless receiver station according to an embodiment of the present disclosure.

In the following, identical reference signs refer to identical or at least functionally equivalent features.

### DETAILED DESCRIPTION

In the following description, reference is made to the accompanying figures, which form part of the disclosure, which illustrate specific aspects of embodiments of the present disclosure or specific aspects in which embodiments of the present disclosure may be used. It is understood that embodiments of the present disclosure may be used in other aspects and comprise structural or logical changes not depicted in the figures. The following detailed description, therefore, is not to be taken in a limiting sense.

For instance, it is to be understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

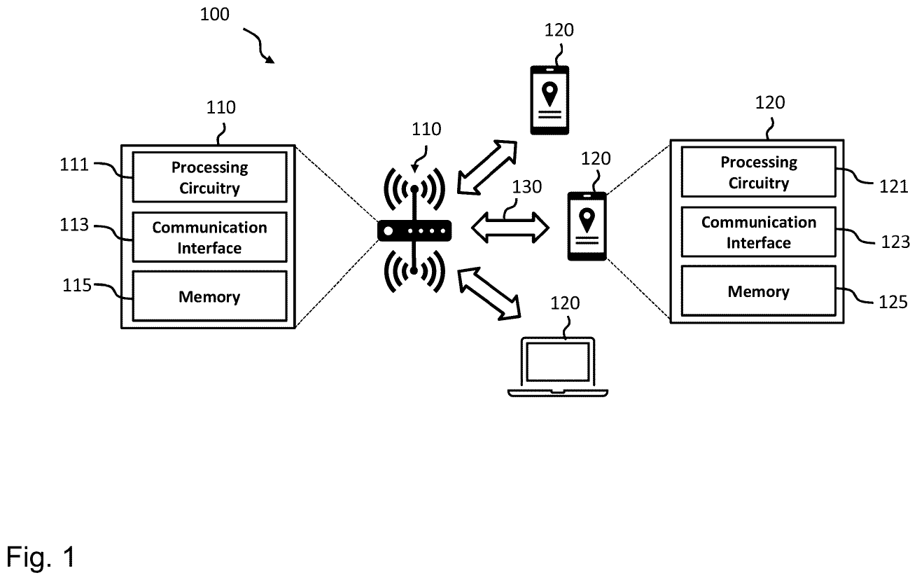

FIG. 1 shows a wireless communication network 100, in particular a wireless communication network in accordance with the IEEE 802.11 framework of standards (also referred to as a Wi-Fi network 100). The Wi-Fi network 100 comprises a Wi-Fi transmitter station 110, which may be implemented in the form of an AP 110, and one or more Wi-Fi receiver stations 120 in the form of, for instance, non-AP stations 120. As illustrated in FIG. 1, by way of example, the non-AP stations 120 may comprise smartphones, laptop computers, tablet computers, desktop computers or other types of wireless devices 120. The Wi-Fi transmitter station 110, e.g. AP 110, may be configured for Multiple Input Multiple Output (MIMO) communication with the one or more Wi-Fi receiver stations 120, e.g. non-AP stations 120. In the following several embodiments of the AP 110 as Wi-Fi transmitter station 110 and the one or more non-AP stations 120 as Wi-Fi receiver stations 120 will be described in more detail below. As will be appreciated, however, the AP 110 may be implemented as a wireless receiver station and each of the non-AP stations 120 may be implemented as a wireless transmitter station as well in accordance with the following embodiments.

As further illustrated in FIG. 1, the AP 110 may comprise a processing circuitry 111 and a communication interface 113, in particular a wireless communication interface 113, e.g. a transceiver 113 enabling OFDM based communication in accordance with the IEEE 802.11 framework of standards over a wireless channel 130. The processing circuitry 111 of the wireless transmitter station 110 may be implemented in hardware and/or software and may comprise digital circuitry, or both analog and digital circuitry. Digital circuitry may comprise components such as application-specific integrated circuits (ASICs), field-programmable gate arrays (FPGAs), digital signal processors (DSPs), or general-purpose processors. The AP 110 may further comprise a memory 115 configured to store executable program code which, when executed by the processing circuitry 111, causes the AP 110 to perform the functions and methods described herein.

Likewise, as indicated in FIG. 1, each of the one or more non-AP stations 120 may comprise a processing circuitry 121 and a communication interface 123, in particular a wireless communication interface 123, e.g. a transceiver 123 enabling OFDM based communication in accordance with the IEEE 802.11 framework of standards over the channel 130. The processing circuitry 121 of each wireless receiver station 120 may be implemented in hardware and/or software and may comprise digital circuitry, or both analog and digital circuitry. Digital circuitry may comprise components such as application-specific integrated circuits (ASICs), field-programmable gate arrays (FPGAs), digital signal processors (DSPs), or general-purpose processors. Each non-AP station 120 may further comprise a memory 125 configured to store executable program code which, when executed by the processing circuitry 121, causes the non-AP station 120 to perform the functions and methods described herein.

Before describing different embodiments of the Wi-Fi transmitter station 110, e.g. the AP 110, and the Wi-Fi receiver station(s) 120, e.g. the non-AP station(s) 120, in more detail, in the following some technical background as well as terminology will be introduced making use of one or more of the following abbreviations:
AP Access Point
CIR Channel Impulse Response
CP Cyclic Prefix
EHT Extremely High Efficiency (802.11be/Wi-Fi 7)
GI Guard Interval
HE High Efficiency (802.11ax/Wi-Fi 6)
IEEE Institute of Electrical and Electronics Engineers
MIMO Multiple Input Multiple Output
OFDM/A Orthogonal Frequency Division Multiplexing/Multiple-Access
PHY Physical (layer)
PPDU Physical Layer Protocol Data Unit
RF Radio Frequency
S/P Serial to Parallel conversion
STA Station, may be an AP STA or a non-AP STA
TD Time Domain
TEQ TD Equalizer
UHR Ultra High Reliability (802.11bn/Wi-Fi 8)
VHT Very High Throughput (802.11ac/Wi-Fi 5)
WLAN Wireless Lan

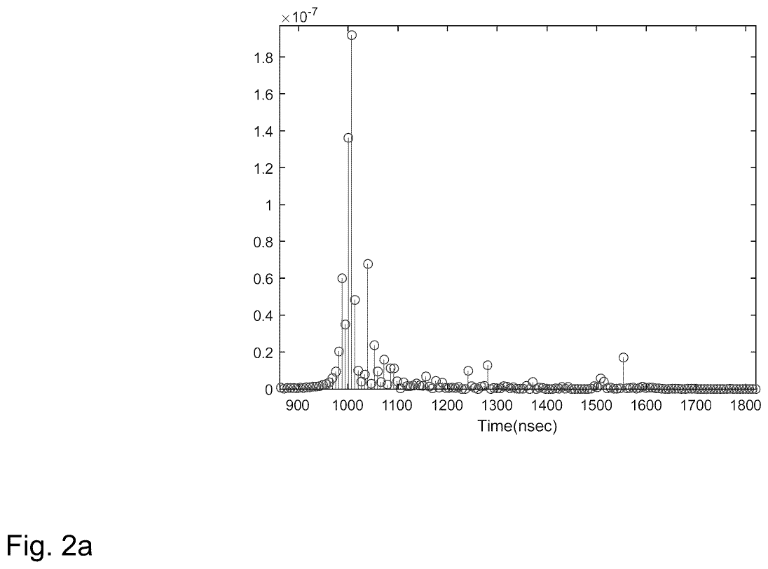

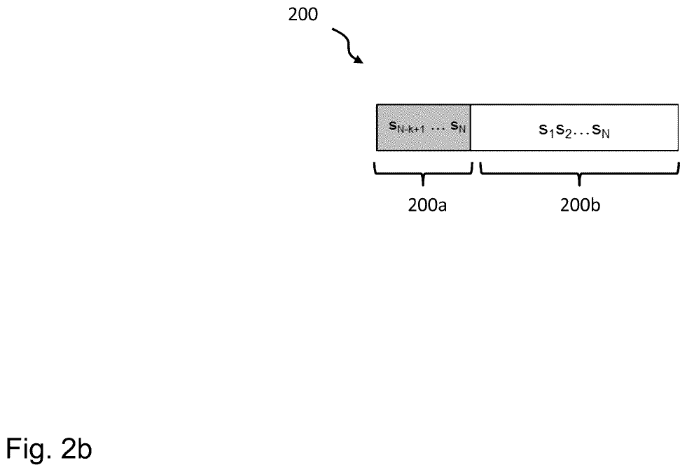

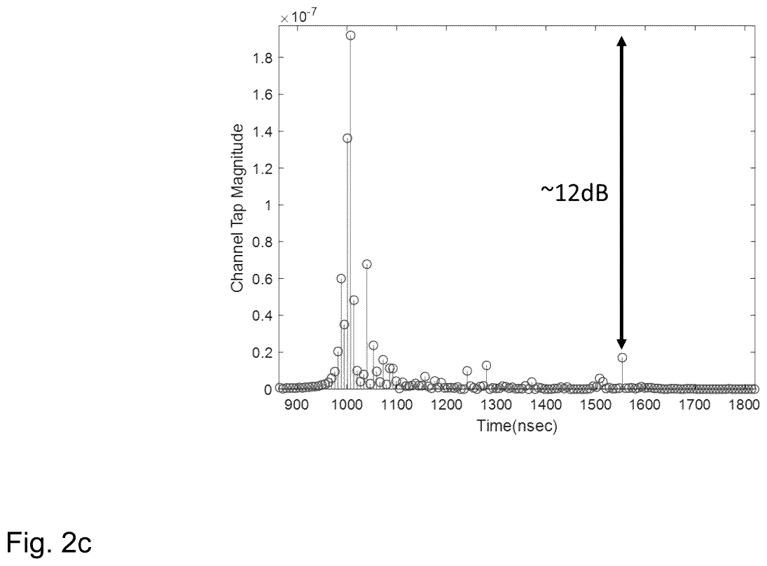

As will be appreciated by the person skilled in the art, a wireless channel, such as the wireless channel 130 illustrated in FIG. 1, may be regarded as a combination of several paths with different delay and attenuation. Each path is produced by a physical process of refraction or reflection of the transmitted signal through different obstacles or from different surfaces, respectively, which are part of the RF signal propagation environment. The surfaces and obstacles produce different attenuation and also change the propagation trajectory of the transmitted signal. Thus, every sample of the received signal in time-domain is produced by the superposition of different transmitted signal samples which propagated over different channel paths. An equivalent way to describe this phenomenon is using a convolution of the transmitted signal with a time-domain filter of several taps, each tap being characterized by its delay, magnitude (or amplitude) and phase. This filter represents the mathematical model of the physical wireless channel in time domain (as illustrated in FIG. 2a). The time difference between the delay of the first (earliest) path and the delay of the last (latest) path of non-negligible magnitude is called the delay spread (of the channel).

In OFDM each symbol generally passes an FFT/IFFT processing stage independently at the receiver/transmitter, respectively. If received samples belonging to different OFDM symbols are included in the FFT processing, inter-symbol interference noise is generated and the receiver performance is degraded. Usually, this issue is solved by the insertion of a guard interval (GI) by the transmitter, wherein the GI, which comprises a copy of the last part of the OFDM symbol, is transmitted before the OFDM symbol itself (as illustrated in FIG. 2b) and is essentially removed/ignored by the receiver. In FIG. 2b the FFT size, which is also the number of samples {S₁, S₂, . . . , S_{N}} comprising the OFDM symbol, is denoted by N, whereas the GI comprises the last k samples (where 0<k≤N) of the OFDM symbol. As will be appreciated, if the GI is longer or equal to the delay spread of the channel, then the samples of previous symbols have no impact on the current symbol and the FFT operation is accurate. However, the GI comprises redundant information and, therefore, results in an overhead, in the sense of occupying the channel during time intervals which are not exploited for transferring new data to the receiver. Thus, it is desirable to have the GI duration as close as possible to the expected delay spread in order to protect the OFDM symbols with minimal overhead.

According to IEEE 802.11ac/ax/be the regular GI interval is ¼ of the OFDM symbol duration. In certain cases, specified in the 802.11ax/be standards, shorter GI intervals of one eighth or one sixteenth of the OFDM symbol duration are also allowed. If mmWave operation reuses the 802.11ac technology with an upclocked signal, it results in shorter OFDM symbol durations. For example, if an 802.11ac signal is upclocked by 8 times, the duration of OFDM symbol will be 400 nsec with a (regular) GI of 100 nsec.

The signal pathloss in the mmWave band is stronger than in the sub-7 GHz band so that for the majority of cases the delay spread values is smaller than 100 nsec. However, in some scenarios, such as indoor enterprise scenarios, the delay spread might be much larger and reach even 500 nsec, as illustrated in FIG. 2c. Although the amplitude of the signal component propagating along the channel's longest path is 12 dB below that of the component propagating along the earliest (first) path, as illustrated in FIG. 2c, this latest-path component is still strong enough to produce significant and harmful inter-symbol interference.

Detailed embodiments of the Wi-Fi transmitter station 110, e.g. AP 110, and the Wi-Fi receiver station(s) 120, e.g. non-AP station(s) 120, will be described in the following that provide a trade-off between robustness to phase noise and supporting long delay spread cases. In other words, embodiments disclosed herein allow to cover very long delay spread values with no performance degradation and minimal overhead.

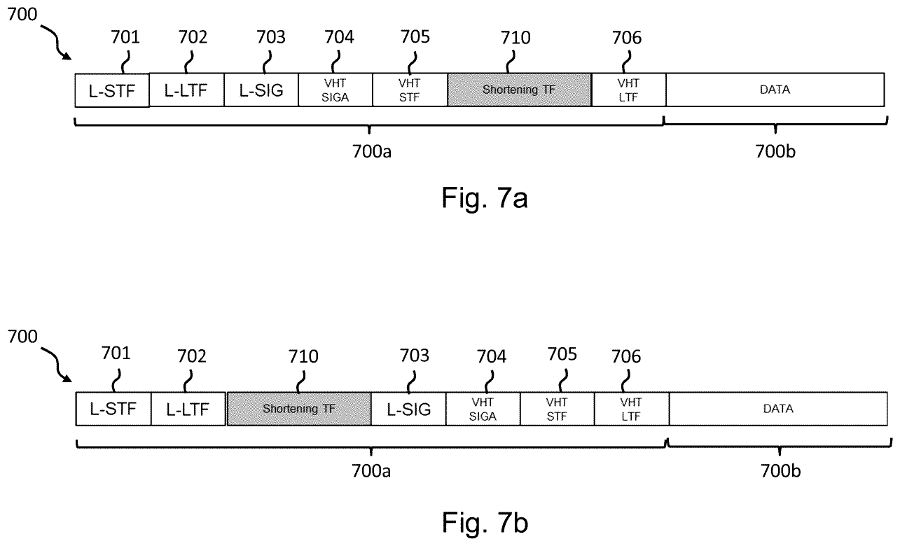

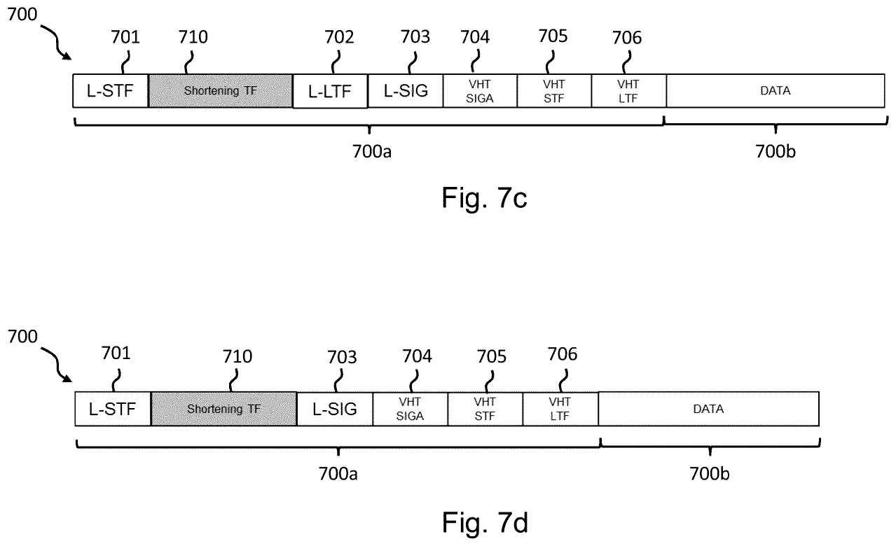

As will be described in more detail in the following, the Wi-Fi transmitter station 110, e.g. AP 110, is configured to generate a signal carrying a physical-layer protocol data unit, PPDU, 700. Different embodiments of the PPDU 700 generated by the Wi-Fi transmitter station 110, e.g. AP 110, are illustrated in FIGS. 7a-7d and will be described in more detail below. The PPDU 700 comprises a preamble part 700a and a data part 700b and the signal carrying the PPDU 700 is modulated by the Wi-Fi transmitter station 110, e.g. AP 110, over a plurality of frequency subcarriers spanning a plurality of OFDM symbols. Moreover, the Wi-Fi transmitter station 110, e.g. AP 110, is configured to transmit the signal to the Wi-Fi receiver station(s) 120, e.g. non-AP station(s) 120, wherein the preamble part 700a of the PPDU 700 further comprises a dedicated field 710 (illustrated in FIGS. 7a-7d) comprising one or more OFDM symbols with a GI duration substantially larger than a GI duration of the plurality of OFDM symbols of the data part 700b of the PPDU 700. In an embodiment, the Wi-Fi transmitter station 110, e.g. the AP 110, is configured to transmit the signal with carrier frequencies above 40 GHz.

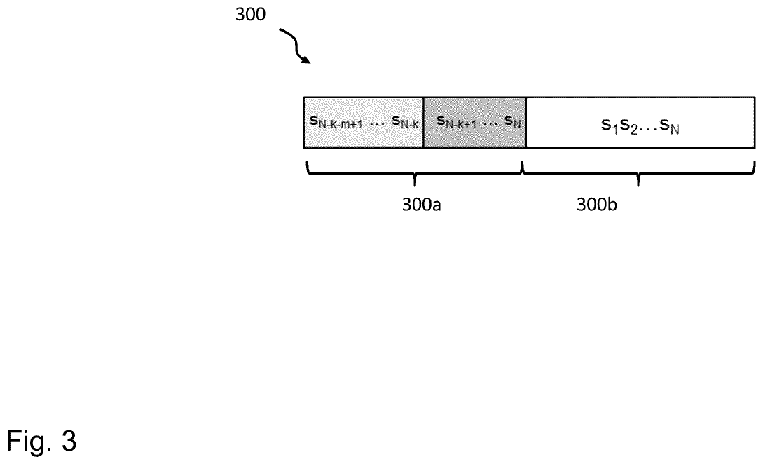

According to an embodiment, the Wi-Fi transmitter station, e.g. the AP 110, is configured to use one or more extended GI durations in specific cases according to the expected channel's delay spread. As illustrated in FIG. 3, in an embodiment, the duration of the extended GI 300a used in the PPDU 700 may be about half of the duration of the whole OFDM symbol 300, namely k′=k+m≈N/2. In other words, in an embodiment, the duration of the extended GI used in the PPDU 700 may be at least twice the conventional GI duration (in which k=N/4, using the notation of FIG. 2b).

In an embodiment, the duration of the extended GI 300a used in the PPDU 700 may be about 200 nsec. This embodiment may be applicable for cases where the Wi-Fi transmitter station 110 generates the signal by upclocking a sub-7 GHz signal to a carrier spacing of 2.5 MHz (corresponding to a GI duration of ½ of the OFDM symbol duration).

In an embodiment, the duration of the extended GI 300a used in the PPDU 700 may be about 400 nsec. This embodiment may be applicable for cases where the Wi-Fi transmitter station 110 generates the signal by upclocking a sub-7 GHz signal to a carrier spacing of 1.25 MHz (corresponding to a GI duration of ½ of the OFDM symbol duration).

In an embodiment, the duration of the extended GI 300a used in the PPDU 700 may be about 500 nsec.

In an embodiment, the Wi-Fi transmitter station 110, e.g. AP 110, may be configured to indicate the presence and/or duration of the extended GI by including one or more indication bits in the preamble part 700a of the PPDU 700.

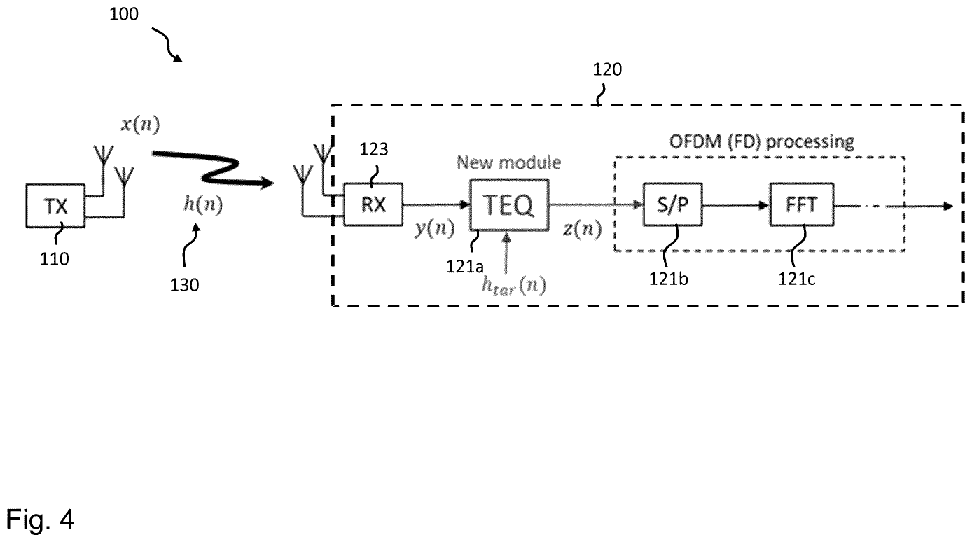

According to an embodiment, the Wi-Fi transmitter station, e.g. the AP 110, is configured to generate the dedicated field 710 of the preamble part 700a of the PPDU 700 as a channel shortening training field 710 such that the one or more OFDM symbols of the dedicated field 710 of the preamble part 700a of the PPDU 700 comprise a channel shortening training sequence. As will be described in more detail in the following in the context of FIG. 4, the Wi-Fi receiver station 120, e.g. non-AP station 120, is configured to apply a channel shortening filter, based on the received channel shortening training sequence, to the received signal for suppressing components of the transmitted signal which reach the receiver via propagation along paths of the wireless channel 130 having delays larger than the GI duration of the OFDM symbols in the data part 700b of the PPDU 700.

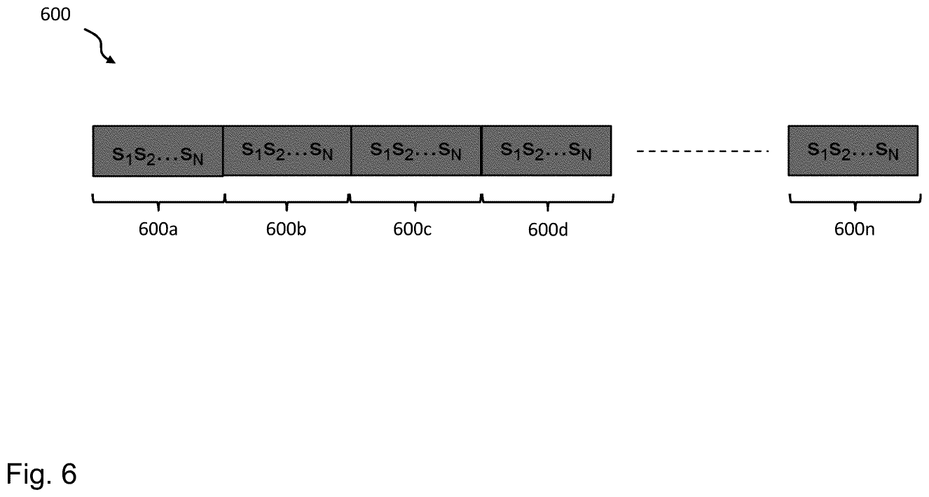

As will be appreciated, channel shortening is a technique where some channel delay taps are suppressed in order to obtain an equivalent channel with a shorter delay spread than that of the physical wireless channel. In particular, channel shortening might be implemented by a dedicated filter that is applied in time domain to suppress channel taps with delay larger than the GI duration. As illustrated in the embodiment of FIG. 4, the Wi-Fi transmitter station 110, e.g. AP 110, may be configured to provide the channel shortening filter as a processing block 121a before the S/P operation 121b and FFT 121c processing. The output signal may be seen as passed through equivalent channel with delay spread smaller or equal to the GI duration. The equivalent (target) channel Hₜₐᵣ is defined by the Wi-Fi receiver station 120 and may be used to obtain the filter coefficients, as illustrated in FIG. 6.

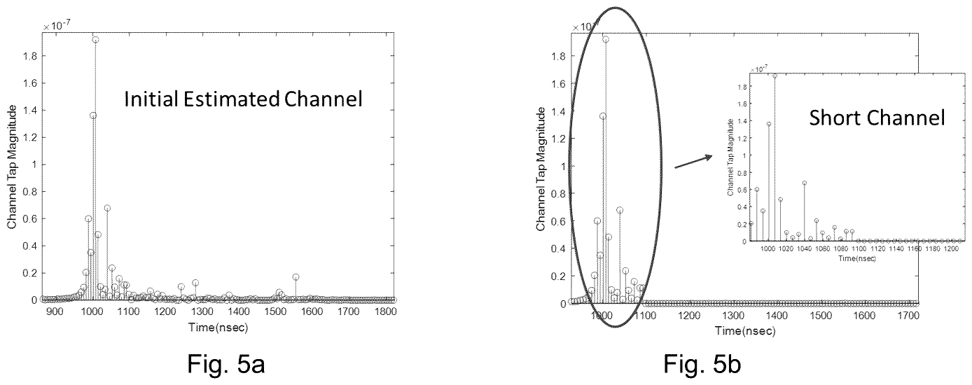

In an embodiment, the Wi-Fi receiver station 120, e.g. the non-AP station 120, may determine the target equivalent channel based on the original channel with long delay spread or a desired channel impulse response. Based on the target channel the Wi-Fi receiver station 120, e.g. the non-AP station 120, may determine the filter coefficients in the following way. Having determined the channel impulse response (CIR) based on the target channel Hₜₐᵣ the Wi-Fi receiver station 120, e.g. the non-AP station 120, may determine a least squares (LS) solution in the following form:

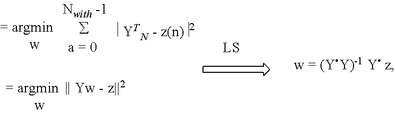

where y denotes the received signal, z=x*Hₜₐᵣ a known signal (i.e. the channel shortening training signal x after being convolved with the target CIR Hₜₐᵣ) and w is the vector of filter coefficients of the TD equalizer (TEQ) to be determined. Once the filter coefficients of the channel shortening filter have been determined by the Wi-Fi receiver station 120, e.g. non-AP station 120, the received signal may be passed through the filter 121 resulting in a shorter equivalent channel, as illustrated in FIGS. 5a and 5b.

In order to be able to estimate the initial channel with high accuracy and to compute the filter coefficients, the Wi-Fi receiver station 120, e.g. non-AP station 120 needs to know the channel shortening training sequence included in the PPDU 700. To this end, in an embodiment, the channel shortening training signal may be generated from a channel shortening training sequence by meeting the following two requirements: (a) the GI used in the channel shortening training field is larger than the physical channel's delay spread; (b) the training sequence contains enough number of samples to ensure an accurate Least Squares solution (as described above).

FIG. 6 is a diagram illustrating a channel shortening training sequence 600 transmitted as part of the preamble part 700a of the PPDU 700 by the Wi-Fi transmitter station 110, e.g. the AP 110, according to an embodiment. The training sequence 600 comprises several repeated OFDM symbols 600a-n (which we index by 1, 2, . . . , n, respectively, where n is an integer larger than 1) without an explicit GI therebetween. As will be appreciated, every OFDM symbol subset 600a-m comprising the m OFDM symbols indexed by {1, 2, . . . , m}, where 1≤m≤n−1, may be regarded as a GI (in the form of CP) of the next n-m OFDM symbols indexed by {m+1, m+2, . . . , n} out of the OFDM symbols 600a-n. Thus, the duration of n−1 replica, namely (n−1). TFFT where TFFT stands for the OFDM symbol duration, defines the maximum delay spread that can be handled using the training sequence 600 illustrated in FIG. 6. It should be appreciated that according to an embodiment, the channel shortening training sequence may be obtained from the sequence 600 by discarding its first l samples, namely the samples {S₁, S₂, . . . , Sₗ} of the subsequence 600a, where l is an integer between 1 and n−1. This would result in a modified training sequence which can cope with maximum delay spread equal to (n−1−l/N). TFFT.

FIGS. 7a-7d are diagrams illustrating the PPDU 700 including the dedicated channel shortening training field 710 for the channel shortening training sequence 600 transmitted by the Wi-Fi transmitter station 110, e.g. the AP 110, according to different embodiments. The embodiments shown in FIGS. 7a-7d are based on the ideas to reuse the long training field (LTF) sequence (limited to the duration of LTF signal) or to use a specifically designed sequence (can be of any duration).

FIG. 7a shows an embodiment, where the dedicated channel shortening training field 710 is added after a legacy preamble (assuming legacy part is modulated using a scheme which is robust enough to be detected and correctly decoded without employing a channel shortening procedure by the receiver). More specifically, in this case, the preamble 700a of the PPDU 700 comprises, in this order, a legacy short training field (L-STF) 701; a legacy long training field (L-LTF) 702; a legacy signal field (L-SIG), 703; a VHT SIGA 704; a VHT STF 705; the dedicated channel shortening training field 710; and a VHT LTF 706.

The embodiments of the PPDU shown in FIGS. 7b-7d may be used for scenarios, where the legacy preamble is not robust enough and the channel shortening training sequence 600 is transmitted before any other fields are transmitted. In this case, there are three options for the location of the dedicated channel shortening training field 710, namely (a) the channel shortening training sequence 600 is transmitted after the L-LTF signal (see embodiment of FIG. 7b); (b) the channel shortening training sequence 600 is transmitted before the L-LTF signal (see embodiment of FIG. 7c); and (c) the channel shortening training sequence 600 replaces the L-LTF signal (see embodiment of FIG. 7d).

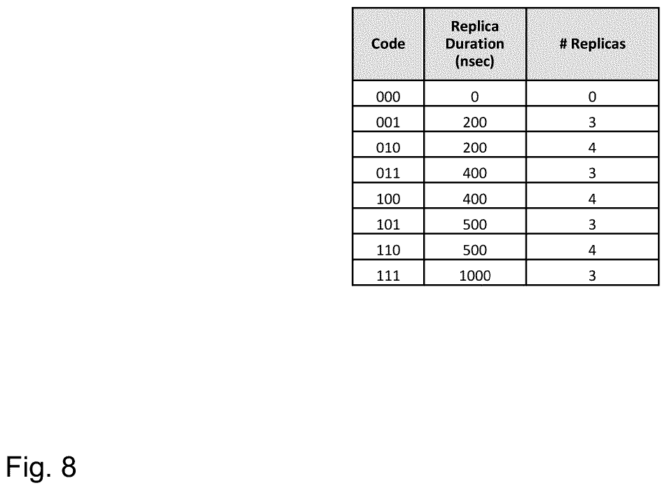

In an embodiment, the Wi-Fi transmitter station 110, e.g. AP 110, is further configured to transit an indication indicative of the presence of the dedicated channel shortening training field 710 to the Wi-Fi receiver station 120, e.g. non-AP station 120. In an embodiment, the indication may be part of the preamble 700a of the PPDU 700 or alternatively part of a beacon frame to indicate periodically the presence of the dedicated channel shortening training field 710. In an embodiment, the indication may comprise a single flag bit (which may be used when the duration of each OFDM symbol replica and also the total number of replicas is constant) or a plurality of bits to indicate different options of replica duration and number of replicas. A table for different options for a three-bit indication is shown in FIG. 8.

In an embodiment, the Wi-Fi transmitter station 110, e.g. AP 110, may be configured to include the dedicated channel shortening training field 710 according to one or more of the following options.

In an embodiment, the Wi-Fi transmitter station 110, e.g. AP 110, may be configured to include the dedicated channel shortening training field 710 in all of its communications, i.e. in all PPDUs. In this embodiment, the dedicated channel shortening training field 710 may have a fixed specific location within the preamble 700a (for example replacing L-LTF as in one of the embodiments described above) so that there is no need to indicate the presence of the dedicated channel shortening training field 710 in a specific PPDU. According to an embodiment, the presence of the dedicated channel shortening training field 710 may be indicated and included within a periodically transmitted frame (such as beacon frame) so that the channel shortening training field 710 is transmitted periodically, such as every 5^{th} frame. In an embodiment (assuming the SIG field is sufficiently robust), the Wi-Fi transmitter station 110, e.g. AP 110, may be configured to decide on a frame-by-frame basis whether to add or not the dedicated channel shortening training field 710 to a PPDU 700. In an embodiment, the Wi-Fi transmitter station 110, e.g. AP 110, may be configured to include the channel shortening training field 710 in every frame.

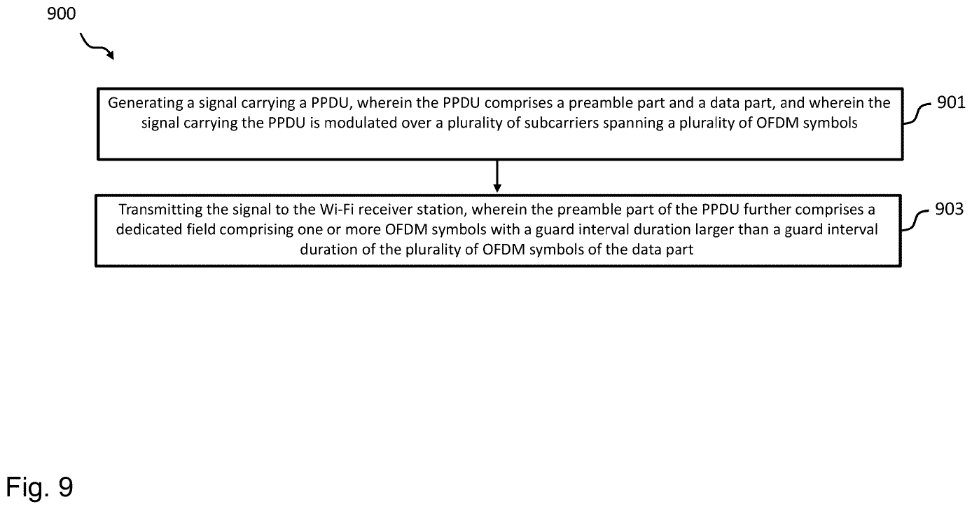

FIG. 9 shows a flow diagram illustrating steps of a Wi-Fi transmission method 900 for OFDM based communication between a Wi-Fi transmitter station, such as the AP 110, and a Wi-Fi receiver station, such as the non-AP station(s) 120, via the wireless channel 130. The method 900 comprises a step 901 of generating a signal carrying a PPDU 700, wherein the PPDU 700 comprises a preamble part 700a and a data part 700b and wherein the signal carrying the PPDU 700 is modulated over a plurality of subcarriers spanning a plurality of OFDM symbols. Moreover, the method 900 comprises a step 903 of transmitting the signal to the Wi-Fi receiver station, such as the non-AP station(s) 120, wherein, as already described above, the preamble part 700a of the PPDU 700 further comprises a dedicated field 710 comprising one or more OFDM symbols 600 with a guard interval, GI, duration larger than a GI duration of the plurality of OFDM symbols of the data part 700b of the PPDU 700.

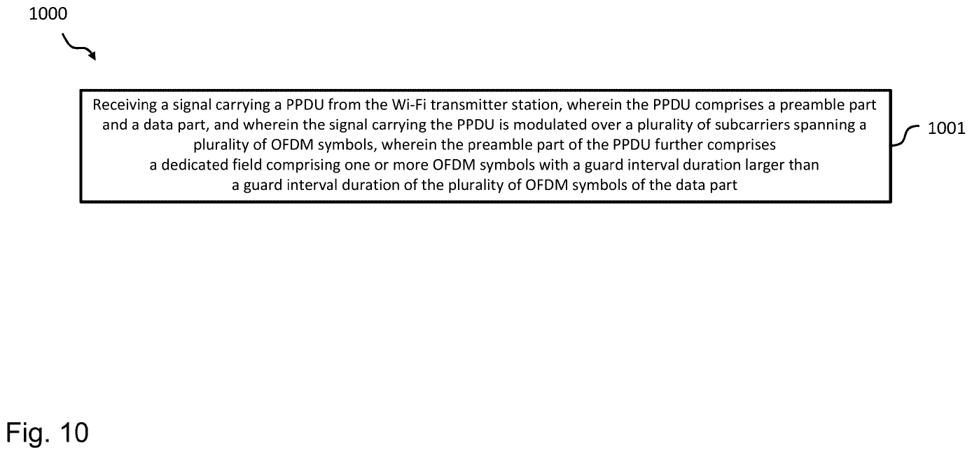

FIG. 10 shows a flow diagram illustrating steps of a Wi-Fi reception method 1000 for OFDM based communication between a Wi-Fi transmitter station, such as the AP 110, and a Wi-Fi receiver station, such as the non-AP station(s) 120, via a wireless channel 130. The method 1000 comprises a step 1001 of receiving a signal carrying a PPDU 700 from the Wi-Fi transmitter station 120, wherein the PPDU 700 comprises a preamble part 700a and a data part 700b and wherein the signal carrying the PPDU 700 is modulated over a plurality of subcarriers spanning a plurality of OFDM symbols. As already described above, the preamble part 700a of the PPDU 700 further comprises a dedicated field 710 comprising one or more OFDM symbols 600 with a GI duration larger than a GI duration of the plurality of OFDM symbols of the data part 700b of the PPDU 700.

The person skilled in the art will understand that the “blocks” (“units”) of the various figures (method and apparatus) represent or describe functionalities of embodiments of the present disclosure (rather than necessarily individual “units” in hardware or software) and thus describe equally functions or features of apparatus embodiments as well as method embodiments (unit=step).

In the several embodiments provided in the present application, it should be understood that the disclosed system, apparatus, and method may be implemented in other manners. For example, the described embodiment of an apparatus is merely exemplary. For example, the unit division is merely logical function division and may be another division in an actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present disclosure may be integrated into one processing unit, or each of the units may exist alone physically, or two or more units are integrated into one unit.

1. A Wi-Fi transmitter station for orthogonal frequency division multiplexing (OFDM) based communication with a Wi-Fi receiver station via a wireless channel, the Wi-Fi transmitter station comprising processing circuitry, wherein the Wi-Fi transmitter station is configured to:
generate a signal carrying a physical-layer protocol data unit (PPDU), wherein the PPDU comprises a preamble part and a data part, and wherein the signal carrying the PPDU is modulated over a plurality of subcarriers spanning a plurality of OFDM symbols; and
transmit the signal to the Wi-Fi receiver station, wherein the preamble part of the PPDU further comprises a dedicated field comprising one or more OFDM symbols with a guard interval (GI) duration larger than a GI duration of the plurality of OFDM symbols of the data part.

2. The Wi-Fi transmitter station of claim 1, wherein the Wi-Fi transmitter station is further configured to transmit the signal with a carrier frequency above 40 GHz.

3. The Wi-Fi transmitter station of claim 1, wherein the preamble part of the PPDU includes one or more bits indicative of the GI duration of each OFDM symbol of the data part being larger than 100 nanoseconds.

4. The Wi-Fi transmitter station of claim 31, wherein the preamble part of the PPDU includes one or more bits indicative of the GI duration of each OFDM symbol of the data part being approximately 200, 400, or 500 nanoseconds.

5. The Wi-Fi transmitter station of claim 1, wherein the duration of the GI inserted between each consecutive pair of OFDM symbols of the data part of the PPDU is not larger than a quarter of the duration of each one of the OFDM symbols.

6. The Wi-Fi transmitter station of claim 5, wherein the dedicated field is a channel shortening training field, wherein the one or more OFDM symbols of the dedicated field comprises a channel shortening training sequence, wherein based on the channel shortening training sequence the Wi-Fi receiver station is further configured to apply a channel shortening filter for suppressing components of the wireless channel having delays larger than the GI duration of the OFDM symbols in the data part of the PPDU.

7. The Wi-Fi transmitter station of claim 6, wherein the channel shortening training sequence comprises a training OFDM symbol and at least one complete or partial copy of the training OFDM symbol.

8. The Wi-Fi transmitter station of claim 6, wherein in the preamble part of the PPDU the channel shortening training field is arranged between a very high throughput (VHT) short training field (STF) and a VHT long training field (LTF), or between fields corresponding to the VHT-STF and/or the VHT-LTF in other Wi-Fi standards.

9. The Wi-Fi transmitter station of claim 8, wherein the channel shortening training field replaces the VHT-LTF or a field corresponding to the VHT-LTF in the other Wi-Fi standards.

10. The Wi-Fi transmitter station of claim 6, wherein in the preamble part of the PPDU the channel shortening training field is arranged after a legacy signal field (L-SIG) and a format of the preamble part preserves a legacy part; or wherein in the preamble part of the PPDU the channel shortening training field is arranged between a legacy long training field (L-LTF) and the legacy signal field (L-SIG); or wherein in the preamble part of the PPDU the channel shortening training field is arranged between a legacy short training field (L-STF) and the legacy long training field (L-LTF); or wherein in the preamble part of the PPDU the channel shortening training field replaces the L-LTF.

11. The Wi-Fi transmitter station of claim 67, wherein the PPDU further comprises an indication indicative of the channel shortening training field.

12. The Wi-Fi transmitter station of claim 11, wherein the indication is further indicative of a number of copies and/or a duration of the training OFDM symbol of the channel shortening training sequence.

13. The Wi-Fi transmitter station of claim 6, wherein the Wi-Fi transmitter station is further configured to transmit a plurality of signals to the Wi-Fi receiver station, and wherein the Wi-Fi transmitter station is configured to include the channel shortening training sequence in all of the plurality of signals.

14. The Wi-Fi transmitter station of claim 6, wherein the Wi-Fi transmitter station is further configured to transmit a plurality of signals to the Wi-Fi receiver station, and wherein the Wi-Fi transmitter station is configured to include the channel shortening training sequence periodically in at least two of the plurality of signals.

15. A Wi-Fi transmission method for orthogonal frequency division multiplexing (OFDM) based communication to a Wi-Fi receiver station via a wireless channel, the Wi-Fi transmission method comprising:
generating a signal carrying a physical-layer protocol data unit (PPDU), wherein the PPDU comprises a preamble part and a data part, and wherein the signal carrying the PPDU is modulated over a plurality of frequency subcarriers spanning a plurality of OFDM symbols; and
transmitting the signal to the Wi-Fi receiver station, wherein the preamble part of the PPDU further comprises a dedicated field comprising one or more OFDM symbols with a guard interval (GI) duration larger than a GI duration of the plurality of OFDM symbols of the data part.

16. The Wi-Fi transmission method of claim 15, wherein the preamble part of the PPDU includes one or more bits indicative of the GI duration of each OFDM symbol of the data part being larger than 100 nanoseconds.

17. The Wi-Fi transmission method of claim 15, wherein the preamble part of the PPDU includes one or more bits indicative of the GI duration of each OFDM symbol of the data part being approximately 200, 400, or 500 nanoseconds.

18. The Wi-Fi transmission method of claim 15, wherein the duration of the GI inserted between each consecutive pair of OFDM symbols of the data part of the PPDU is not larger than a quarter of the duration of each one of the OFDM symbols.

19. The Wi-Fi transmission method of claim 18, wherein the dedicated field is a channel shortening training field, wherein the one or more OFDM symbols of the dedicated field comprises a channel shortening training sequence, wherein based on the channel shortening training sequence the Wi-Fi transmission method further comprises applying a channel shortening filter for suppressing components of the wireless channel having delays larger than the GI duration of the OFDM symbols in the data part of the PPDU.

20. The Wi-Fi transmission method of claim 19, wherein the channel shortening training sequence comprises a training OFDM symbol and at least one complete or partial copy of the training OFDM symbol.
